(19) United States
(12) Patent Application Publication
(10) Pub. No.: US 2013/0118994 A1
(43) Pub. Date: May 16, 2013

(54) System and Methods for Wastewater and Produced Water Cleaning and Reclamation

(71) Applicant: Richard Altman, Kingwood, TX (US)

(72) Inventor: Richard Altman, Kingwood, TX (US)

(73) Assignee: R360 ENVIRONMENTAL SOLUTIONS, Houston, TX (US)

(21) Appl. No.: 13/426,346

(22) Filed: Mar. 21, 2012

Related U.S. Application Data
(60) Provisional application No. 61/454,804, filed on Mar. 21, 2011.

(51) Int. Cl. C02F 1/463

(52) U.S. Cl. CPC C02F 1/463
USPC 210/748.12; 205/751; 210/748.16; 204/232; 204/240; 210/205

(57) ABSTRACT

Systems and methods have been developed for treating waste water and produced water, so as to remove contaminants therefrom. The systems and methods allow specifically for the removal of contaminants from produced water from oil and gas wells, fracturing flow-back water, and water- or brine-based drilling fluids. The water is treated by contacting the contaminated fluid with ozone after contacting the fluid with a diffused air system to generate small bubbles for entrainment of some contaminants. Thereafter, the water is contacted with an electro-coagulation system in order to remove flocculants and adjust the pH and the total dissolved solids levels of the fluid.

### CROSS REFERENCE TO RELATED APPLICATIONS

This application claims priority to U.S. Provisional patent application Ser. No. 61/454,804, filed Mar. 21, 2011, the contents of which are incorporated herein by reference in their entirety.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

Field of the Invention. The inventions disclosed and taught herein relate generally to water purification, and more specifically are related to methods and systems for treating and purifying produced water.

### DESCRIPTION OF THE RELATED ART

The production of aqueous and gaseous hydrocarbon commodities through boreholes from geologic repositories is typically accompanied by the production of waste drilling fluids and drilling fluid additives, formation waters, and, in the specific cases of thermal stimulation wells, the production of spent steam injection liquors. In all cases, the borehole-produced waters are organic- and inorganic-content contaminated relative to the water quality standards promulgated by potential surface users, including irrigators, potable water distributors, industrial steam producers and most other industrial use standards. These contaminated borehole waters are referred to as “oil-gas field produced” and “oil-gas field flow-back” waters and will be referred to hereafter in this document as a species of “produced” water.

Oil-gas field produced water is most often a blend of geologic formation water and surface water that has been injected into the formation during the processes of well-drilling, well-stimulation, or geologic formation conditioning, as for example by the injection of steam into a formation. The produced water from a single borehole can exhibit a wide range of oxidation-reduction potentials and dissolved solids contents relative to the mix of formation and introduced waters and the conditions of pressure of depth of burial and autonomic heating effects. Also, a wide range of soluble and insoluble organics and biota may be present in the produced water, again, as contributed by the geologic and introduced sources of the water. Also, there can be a wide variation on the ratio of contaminants present for any given borehole on a time basis, with time zero typically being that point in time where there is a massive injection-introduction of surface sourced water and contaminants; also called the point of “well stimulation.” At time zero, the introduced water, polymer and chemical contamination of the water is at its highest level, and, typically, the geologic source components of the contamination of the water is at its lowest level. With the passage of time, the ratio of surface-sourced, introduced, contamination relative to geologic source contamination reverses itself in favor of the geologic source component.

The extraction of hydrocarbons from subterranean formations through a variety of processes, including hydraulic fracturing, drilling, and water flooding operations, generates large volumes of contaminated water that is referred to herein as “produced water.” Most produced water is contaminated with inorganic salts, metals, organic compounds, and other materials in varying amounts, depending upon what the water was used for (e.g., fracturing, drilling, or water flooding). The most abundant hydrocarbons in produced water include semivolatile organic compounds (“SVOCs”) and volatile organic compounds (“VOCs”). Volatile organic compounds typically include dissolved benzene, toluene, ethylbenzene, and xylenes, collectively referred to as “BTEX.” Other organic constituents in produced water include organic acids, oils, paraffins, and waxes. Volatile inorganic constituents include hydrogen sulfide.

Because they are contaminated, oil-gas field produced waters are not typically surface dischargeable, except as might be allowed by a special exemption. These exemptions are typical to the industry and are usually written around the concept of produced water discharge to evaporation ponds. This practice of produced water discharge to evaporation ponds has recently been identified to be “wasteful” both in regards of the potential benefits that might accrue to immediate, area adjacent, alternative uses of the water and the loss of productivity of land inundated by the evaporation ponds. For these reasons, there is social pressure to investigate the efficacies of the treatment of oil-gas field produced waters to the alternate beneficial end-use water quality standards of irrigation, human consumption and industrial processes.

The present-day economics of hydrocarbon production have enabled fields that are large volume, geologic source water producers to be brought on-line. In other cases, large water volume producing “heavy oil” reserves have been brought on-line by the use of introduced source, steam, injection techniques. In other cases, large-volume water production fields have been created from “tight” hydrocarbon-containing geologic formations by the use of water injection “hydro-fraccing” (also referred to as hydraulic-fracturing).

These increased water volume production fields have exacerbated surface land use and water waste issues. For some fields, the surface pond discharge option has been legislatively obviated because the large land surfaces required for the ponds led to a public outcry and loss of a social-license-to-operate, except by the adoption of more natural resource conservative methods. In a case like this, the first response of the industry is to defuse the “land use” conflict by deep-well disposal of the offending contaminated water. Although the deep-well disposal method managed the negative land-use aspects of large area evaporation pond construction, it did not negate criticism of the “wasting” of water resources. While the industry contends the ground water brought to the surface in its operations is returned to the ground water state by the act of underground disposal, the public sees the deep-well process as a loss of a precious surface water asset.

While this debate continues, an additional factor has entered the production equation in the form of the high cost to transport the water to the deep-well sites. This water transportation cost has essentially doubled over the course of the last decade due to the global tightening of petroleum product supplies and attendant fossil-fuel price increases. Because the tightened petroleum product supply is predicted to be endemic, the oil-gas industry has determined that the time of borehole-produced water treatment and waste minimization is the path both to increased hydrocarbon production profitability and an improved social profile relative to the land use and water conservation issues.

While the oil-gas industry has recognized the need for bore-produced water purification, it has had few economically viable and effective water treatment technologies from which to choose. By way of example, oil and gas field “produced” waters are typically laden with dissolved solids and classified as “brackish” waters. The treatment of the brackish well-bore water produced by wells that have been stimulated, especially those wells that have been fractured (or “fracc'd”) or subjected to any number of work-over operations, have been refractory to conventional pure water extraction processes, specifically the methods of membrane “reverse osmosis” (RO) desalinization. The refractoriness of the water has been manifest as a tendency of the water to “foul” as in the formation of a membrane surface coating that retards the membrane permeate production process and frustrates the pure water production intent of the process. When treating the well-bore water from stimulated or otherwise treated wells, the membrane process-interfering surface coating appears to form immediately upon water-membrane contact. Because oil and gas field produced waters from non-stimulated wells is comparatively non-fouling relative to the “immediate coating formation” phenomena of the stimulated well waters, the fouling is deduced to be a result of the stimulation process, specifically the chemical additions that are typically used as part of the fracturing (hydraulic or otherwise) process. In the typical fracturing process, sand or other suitable proppants are forced under pressure into cracks that are pressure induced into the oil or gas production formation. The proppant is carried deep into the cracks by a viscous gel and/or slickwater or the equivalent. Viscous gel, for instance, is typically made by a mix of water and “guar flour” (ground endosperms of Cyanopsis tetragononoloba: the flour is 85% water soluble and called guaran, and the water soluble components are principally galactose 35%, 63% mannose and 5-7% protein) or a similar natural gum (guar gum) or cellulose material (e.g., hydroxymethyl cellulose, HMC). The gel is then “broken” or “thinned” to allow the release of sand at the sand's point of furthest ingress into the formation crack; the breaking process is usually affected by an “enzyme breaker.” The broken gel is referred to as the “broken organic” component of the fracturing “flow back water.”

As the treatment of produced water has become an environmental and cost-effective option for addressing produced water as an oilfield “waste material,” operators have realized that the treatment of produced water has the potential to be a harmless and valuable product rather than a waste to be disposed of. Many separate and combined physical, chemical, and biological methods have been proposed for produced water treatment to date, although many have significant limitations.

For example, physical treatment methods such as adsorption onto filter materials such as clays and sand filtration have been suggested. The EARTH Canada Corporation has developed a technology called Total Oil Remediation and Recovery (TORR™) to remove and recover dispersed oil in water 2 μm and larger, using a multi-stage adsorption and separation system. However, the main drawback of such adsorption systems is the need for frequent and often costly regeneration of material and the generation of additional waste. Other processes, such as coagulation, the use of aerobic and anaerobic microorganisms [Freire, et al., Environ. Technol., Vol. 22, pp. 1125-1135 (2001)] and chemical treatments such as photocatalytic treatments [Bessa, et al., Appl. Catal. B, Vol. 29, pp. 125-134 (2001); Li, et al., J. Hazardous Materials, Vol. B138, pp. 392-400 (2006)] and hydrolysis acidification-dynamic membrane bioreactor-coagulation processes [Zhang, et al., J. Petroleum Science and Engineering, Vol. 74, pp. 14-19 (2010)] have proven to be successful only on the laboratory scale. Consequently, the need for improved methods and systems for purifying wastewater and production water is clear.

The inventions disclosed and taught herein are directed to improved systems and methods for the purification of wastewater and production water streams.

### BRIEF SUMMARY OF THE INVENTION

These and other needs are addressed by the various embodiments and configurations of the present disclosure. The present invention is directed generally to the treatment of aqueous feed streams including one or more organic and/or inorganic constituents. In a particularly desirable application, the methods and systems of the present disclosure are used to form a purified water product from produced water or wastewater streams for recycling, reuse, or clean-up and remediation.

In accordance with a first embodiment of the present disclosure, a water treatment method is described, the method comprising transferring water contaminated with at least one contaminant selected from the group consisting of inorganic compounds, organic compounds, and gases; contacting the contaminated water with a diffusion-aeration treatment system for introducing diffused bubbles into a stream of contaminated water, thereby generating a volatile organic fraction containing hydrocarbon molecules and a contaminated diffusion-aeration system effluent; aerating the diffusion-aeration system effluent in an aeration system for a residence time sufficient to generate an aeration system effluent; separating solids from the aeration system effluent with a filter means to generate a filtered aeration effluent stream; contacting the filtered aeration effluent stream with an electro-coagulation system for a residence time sufficient to generate flocculants in the electro-coagulation system effluent; and separating solids from the electro-coagulation system effluent with a filtration system to obtain an aqueous fluid stream with a pH of about 7.

In accordance with a further embodiment of the present disclosure, a water treatment method for purifying contaminated produced water is described, the water treatment method, the method comprising collecting water contaminated with at least one contaminant selected from the group consisting of inorganic compounds, organic compounds, and gases to create a collection water; electro-coagulating solids and/or metals entrained in the collection water to generate flocculants in the aeration effluent thereby creating an electro-coagulation effluent; aerating the electro-coagulation effluent with at least one oxidizing agent to reduce metals, hydrocarbons, or other reducing agents in the filtered electro-coagulation effluent to create an aeration-oxidation effluent; sanitizing the aeration-oxidation effluent to create a sanitized effluent; degassing the sanitized effluent for a sufficient time to allow the removal of a substantial portion of any gaseous oxidation agent from the sanitized aeration-oxidation effluent creating a final effluent; and storing the final effluent. In further accordance with aspects of this embodiment, the method of aerating the electro-coagulation effluent further comprises: aerating the electro-coagulation effluent with a first oxidizing agent to create an first oxidized electro-coagulation effluent; and aerating the first oxidized electro-coagulation effluent with a second oxidizing agent to create the aeration-oxidation effluent.

In accordance with a further embodiment of the present disclosure, a water treatment method for purifying contaminated produced water is described, the method comprising collecting water contaminated with at least one contaminant selected from the group consisting of inorganic compounds, organic compounds, and gases to create a collection water; aerating the collection water with a gas for a sufficient time to generate a volatile organic fraction containing hydrocarbon molecules and a contaminated aeration effluent; electro-coagulating solids and/or metals entrained in the contaminated aeration effluent to generate flocculants in the aeration effluent thereby creating an electro-coagulation effluent; aerating the electro-coagulation effluent with at least one oxidizing agent to reduce metals, hydrocarbons, or other reducing agents in the filtered electro-coagulation effluent to create an aeration-oxidation effluent; sanitizing the aeration-oxidation effluent to create a sanitized effluent; degassing the sanitized effluent for a sufficient time to allow the removal of a substantial portion of any gaseous oxidation agent from the sanitized aeration-oxidation effluent creating a final effluent; and storing the final effluent. In further accordance with aspects of this embodiment, the contaminated water is selected from the group consisting of produced water, formation water, fracturing flow-back water, and aqueous-based drilling fluids. In accordance with yet another aspect of this embodiment, the method further includes the step of aerating the electro-coagulation effluent further comprises aerating the electro-coagulation effluent with a first oxidizing agent to create an first oxidized electro-coagulation effluent; and aerating the first oxidized electro-coagulation effluent with a second oxidizing agent to create the aeration-oxidation effluent.

In accordance with a further embodiment of the present disclosure, a system of treating contaminated water is described, the system comprising an aeration filtration assembly for introducing diffused gas bubbles into a stream of contaminated water, thereby generating a volatile organic fraction containing hydrocarbon molecules and a contaminated first aqueous fraction; an electro-coagulation system in fluid communication with the diffusion-aeration assembly for the electrolytic treatment of the fluid stream, the electro-coagulation system comprising at least one reactor cartridge configured for installation into and removal from the electro-coagulation system, the at least one reactor cartridge comprising a plurality of electrodes formed of a selected material and having a selected configuration; and means for transporting the fluid from the diffusion-aeration assembly to the electro-coagulation system. In accordance with further aspects of this embodiment, the system may further include an oxidation means associated with the -aeration assembly, capable of being in contact with the aqueous feed stream, wherein the oxidation means is an ozone-containing gas stream or ozone-introducing assembly. In yet another aspect of this embodiment of the disclosure, the system advantageously includes one or more filter assemblies in fluid communication with the aqueous feed stream.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1 illustrates an exemplary flow chart of the general purification process and system of the present disclosure.

FIG. 2 illustrates an exemplary flow chart of an alternative purification process and system of the present disclosure.

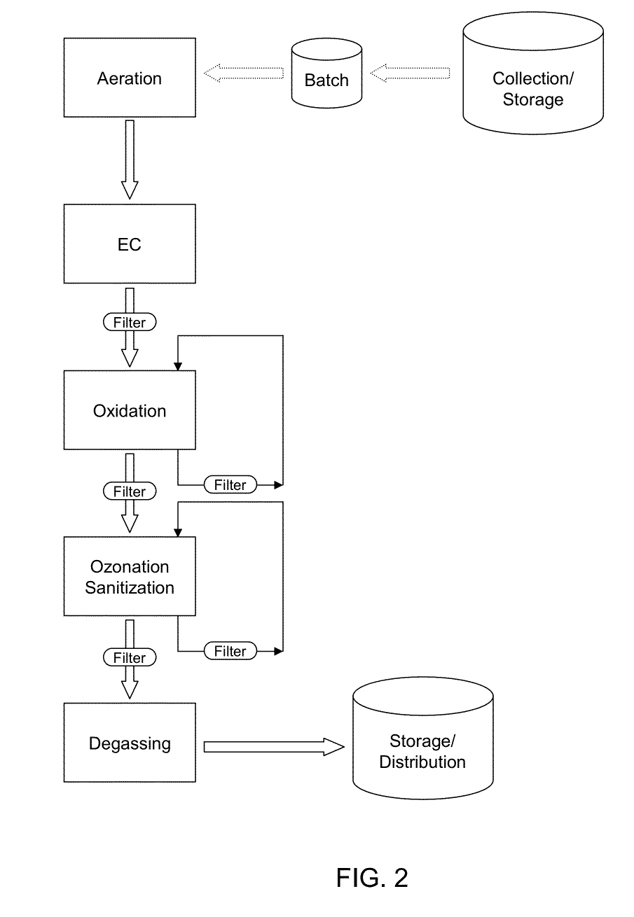

FIG. 3 illustrates a generalized schematic illustration of an exemplary embodiment system for generating treated water from produced water.

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DEFINITIONS

The following definitions are provided in order to aid those skilled in the art in understanding the detailed description of the present invention.

The term “formation water” or “connote water”, as used herein, refers to water that is naturally occurring within subsurface formations and which may be permeated by different underground fluids such as oil, gas, and saline water.

The term “production water” or “produced water”, as used herein, refers to saline water mixed with hydrocarbons and/or injected fluids and additives resulting from hydrocarbon recovery operations when it comes to the surface. Such water is typically a mixture of organic and inorganic materials, having a variety of physical and chemical properties in association with the nature of the producing/storage geological location from which they are withdrawn, geological formation, lifetime of its reservoirs, and type of hydrocarbon product being produced.

The term “Newtonian fluid” as used herein refers to a fluid wherein the relationship between the shear stress and the strain rate is linear (the coefficient of linearity being the viscosity) and is independent from other factors, with the exception of temperature.

The term “electro-coagulation”, or “EC”, refers to physio-chemical reactions used in water treatment involving the precipitation of ions (heavy metals) and colloids (organic and inorganic) which are mostly held in solution by electrical charges, through the use of an electro-coagulation reactor or system. By the addition of ions with opposite charges, these colloids can be destabilized; coagulation can be achieved by chemical or electrical methods. A typical electro-coagulation reactor is made up of an electrolytic cell with one anode and one cathode. When connected to an external power source, the anode material will electrochemically corrode due to oxidation, while the cathode will be subjected to passivation. An EC system essentially consists of pairs of conductive metal plates in parallel, which act as monopolar electrodes.

### DETAILED DESCRIPTION

The Figures described above and the written description of specific structures and functions below are not presented to limit the scope of what Applicants have invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations. In some alternate implementations, the functions/actions/structures noted in the figures may occur out of the order noted in the block diagrams and/or operational illustrations. For example, two operations shown as occurring in succession, in fact, may be executed substantially concurrently or the operations may be executed in the reverse order, depending upon the functionality/acts/structure involved.

Applicant has created methods and systems for the efficient treatment and reclamation of aqueous waste streams, including waste water and produced water from hydrocarbon recovery operations, the methods including treatment with ozone and/or electro-coagulation methods in combination with further, optional purification steps, including but not limited to filtration.

The principle object of the instant disclosure is to provide extremely efficient, low maintenance, low energy cost modular water purification and contamination control technology for the non-chemical disinfection and contaminant separation of various types of water or wastewater streams. The water treatment and purification areas of particular interest include, but are not limited to, drinking water, ship ballast water, marine discharge wastewaters, commercial and industrial cooling water, industrial and commercial hazardous and/or toxic effluents, manufacturing process water, industrial machine tool coolants, sewage, hydrocarbon recovery (oil or gas) produced waters, and agricultural and food processing streams. In accordance with a particular preferred aspect of the present disclosure, the methods and systems described herein are applicable to produced water effluent streams associated with hydrocarbon recovery operations, including but not limited to aqueous fracturing fluid flow-back streams, water- or brine-based drilling fluids, water flood flow-back streams, aqueous breaker fluids, and other water-based fluids associated with one or more hydrocarbon recovery operations.

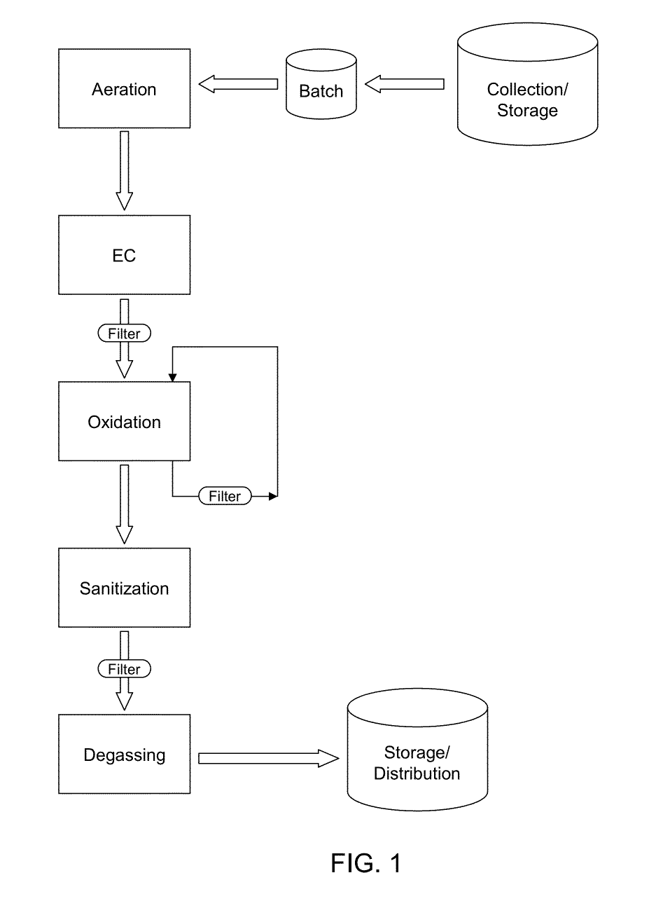

Turning now to the figures, FIG. 1 is a general illustration of a flowchart of the process methods of the present disclosure. As shown therein, contaminated produced water is collected and may be stored on site in a collection/storage tank or other suitable facility such as a storage pond or other holding tank (hereinafter collectively referred to as “storage tank”). Optionally, batches of the collected contaminated produced water may be isolated for testing and subsequent treatment. Such batch treatment may be utilized where collection of contaminated produced water occurs from a variety of sources or from a variable source, thus allowing for modification and customization of the contaminated produced water treatment process to specific contaminated produced water characteristics. Where a batch treatment process is desired, contaminated produced water is supplied to a storage tank or tanks from, for instance, tanker trucks or a pipeline source. Contaminated produced water of varying characteristics, compositions, and/or sources is thereby comingled in the storage tank or tanks. Prior to beginning the treatment process, a batch or specific volume of contaminated produced water is transferred to a batch tank, where characteristics, such as pH and concentration of various contaminants, can be measured. The volume of the batch tank and/or a specific batch of contaminated produced water may be based on the throughput capacity of the water treatment system. Characteristics of the batch of contaminated produced water may be altered or modified for optimization of the downstream treatment process. For instance, downstream separation of hydrocarbon fractions via aeration or downstream flocculation of solids may be more efficient at a particular pH range, such as a circumneutral pH, and the pH of the initial batch of contaminated produced water may be treated to adjust the pH with, for instance, a de-acidifying agent such as sodium hydroxide.

The contaminated produced water is first subjected to an aeration process, in which the contaminated produced water stream to be purified is transported via pump, gravity flow, or other appropriate fluid transport means, to an aeration system. Where a pump is used, optimally, a rotary lobe, mono or diaphragm pump is utilized to feed to flow stream at a suitable rate into the aeration system or apparatus so as to reduce the searing effect on the fluid. Where a pump introduces an undesirable shearing effect to the contaminated produced water flow stream, the contaminated produced water is further mixed thereby further entraining the contaminating hydrocarbons into the contaminated produced water. Varying volumes of an appropriate miscible and/or inert gas (such as carbon dioxide and/or nitrogen) flows through the aeration system and introduces small (on the order of about 5 μm) gas bubbles into the flow stream via diffusion or injection. Advantageously, the small bubble sizes prepared will enhance the oil recovery of the produced water, and remove the bulk of the hydrocarbons from the water stream.

The choice of gas used in the aeration process can vary depending on the characteristics of the contaminated produced water and the specific implementation of the purification system or method. For instance, where the contaminated produced water to be treated is found to have a higher than circumneutral pH, varying amounts of carbon dioxide may be used in the aeration process, resulting in a lowering of the pH of the contaminated produced water to be treated.

The aeration system useful in the processes of the present disclosure may be any suitable gas diffusion system capable of producing diffused gas bubbles, such that gas bubbles introduced into the fluid stream have a size ranging from about 1 μm to about 10 μm, preferably about 5 μm, and introducing such bubbles into the fluid stream to be purified into so as to effectively entrain and remove hydrocarbons from the aqueous fluid stream. An exemplary aeration system would comprise a gas diffusion system suitable for use in accordance with the present disclosure is that described in U.S. Pat. No. 7,137,620 to Thomas et al. and a multi-staged or chambered induced gas floatation (“IGF”) or diffused air floatation (“DAF”) system to maximize the efficiency of separating the hydrocarbons from the contaminated produced water. The aeration system should be sized to allow for adequate retention time of the contaminated produced water to be treated, such that micro bubbles of diffused or injected gas can contact substantial portions of the contaminated produced water and float and isolate hydrocarbons in the water. The separated hydrocarbons can be isolated and reclaimed for commercial use or disposal. Where the contaminated produced water is substantially free of hydrocarbon contamination, or hydrocarbons otherwise need not be removed from the contaminated produced water, this initial aeration process may be unnecessary for the treatment process.

The fluid stream is then conveyed to an electro-coagulation unit, or, in the case where removal of hydrocarbons is not required, the contaminated produced water may be provided directly from the collection/storage or batch tank to the electro-coagulation unit. As will be understood by a person of skill, an electro-coagulation unit for water treatment may take many forms. Generally, it will consist of a vessel through which the contaminated produced water will pass such that the contaminated produced water passes between electrified electrodes, resulting in the flocculation of entrained solids and/or metals, including clays, silts, non-metal, and metal contaminants. Electrodes in the electro-coagulation unit may be comprised of a variety of materials, as will be generally understood, and the choice of electrode materials may generally account for the expected composition of contaminants in the contaminated produced water. Suitable electrode materials include, but are in no way limited to, steel and aluminum, as would be understood to persons of skill.

Exemplary electro-coagulation systems suitable for use with the present disclosure include assemblies with self-contained reactor cartridges which allow for rapid reactor cartridge exchange, such as that described in U.S. Pat. No. 6,780,292 to Hermann et al. Such a system, particularly a cartridge-based system, can significantly reduce the down-time that is typically required to change electrodes, which tend to become coated within a short period of time and subject electro-coagulation systems to frequent maintenance. Additionally, electro-coagulation systems such as those contemplated for the present application may optimally have a power modulation and control system associated therewith, such as through a computer system, which allows for a constant, varied, or programmed change in current flow, polarity, and/or magnitude across the electro-coagulation system electrodes, thus allowing for an extended use lifetime for the plates from hours to a day or more, thereby reducing frequency of system down-time associated with the electrode maintenance.

After being subjected to the electro-coagulation process, depending upon the quantity of entrained solids in the contaminated produced water fluid stream, the fluid stream may be re-circulated one or more times back through the electro-coagulation unit, as appropriate, in order to maximize the amount of flocculation of entrained solids and/or metals. The re-circulation process may be accompanied by filtration of the fluid stream to remove the flocculated solids. The fluid stream exiting the electro-coagulation unit may then be purged with one or more gases, such as nitrogen, in order to “normalize” the treated water product.

The fluid stream exiting the electro-coagulation unit is filtered to remove the flocculated solids. Depending on the characteristics of the contaminated produced water, removal of the flocculated solids may be important for the efficacy of the oxidation processes that would occur downstream of the electro-coagulation unit. Presence of flocculated particles in the contaminated produced water will tend to reduce the efficiency of these oxidation processes by increasing the oxidation load of the contaminated produced water. These oxidation processes are discussed in detail below.

For filtration of the effluent from the electro-coagulation unit, as well as for the other filtration processes discussed for use in the present invention, suitable filters and filtration systems include, but are not limited to, bulk filtration units and methods, SOC (Synthetic Organic Chemical) filters, dual-pod filters, sub-micron filtration, filters using a variety of media (including ion-exchange resins, ceramics, clays, and the like), semi-permeable membranes, and filter processes utilizing a variety of filtering processes, including but not limited to the group consisting of ceramic microfiltration, activated carbon treatment, membrane separation (including membrane separation by reverse osmosis), ion exchange chromatography, and/or pH adjustment filtration processes. Such filters and filtration systems suitable for use within the present disclosure may be used singly, or may be arranged in sequence or parallel, and may be fixed or moving bed. The fluid flow rate of the water streams through the present systems will depend on whether the fluid is transferred via pump or gravity flow. However, the typical flow rates for fluids through the systems described herein range from about 0.1 bbl/min (barrels per minute) to about 100 bbl/min, more typically from about 0.25 bbl/min to about 50 bbl/min, and more typically from about 0.25 bbl/min to about 25 bbl/min, scaled depending upon the particulars of the fluid being purified and the system being used.

Following filtration of the electro-coagulation effluent, the contaminated produced water is subjected to one or more oxidation processes. During the oxidation process diffused gas bubbles are introduced into the fluid stream to be purified, such that gas bubbles introduced into the fluid stream have a size ranging from about 1 μm to about 10 μm, preferably about 5 μm, so as to effectively entrain and remove hydrocarbons from the aqueous fluid stream. The oxidation processes may be accomplished with the use of aeration systems like those discussed above, with the generation of micro bubbles with a gas diffusion system and diffusion or inducement of those micro bubbles into the fluid stream to be purified using, e.g., IGF or DAF systems. Other systems may be applied as understood by those of ordinary skill in the art to introduce oxidizing agents into the fluid stream to be purified. The specific oxidizing gas used in the initial oxidizing tank may be any appropriate gas as chosen by one of skill based on the composition of the reduced contaminants in the produced water, and would include ambient air.

The oxidation process may occur using one or more discrete steps, each associated with the aeration of a different oxidizing gas into the produced water. For example, as is discussed below, an oxidizing step using ambient air, followed by a second oxidation process using ozone. While ambient air and ozone are two appropriate gases for use in a multiple-step oxidation process, any suitable oxidizing gas may be used and should be chosen with consideration of the composition of the contaminant material sought to be removed from the produced water. To improve the efficiency of each sequential oxidation process, the produced water may be filtered following the introduction of each oxidizing gas to remove oxidized particles.

The oxidation process may occur in one or more oxidation tanks, into which micro bubbles of oxidizing gas are introduced. Within each tank, the produced water may be circulated, continuously or after allowing time for oxidative reactions, and may additionally be filtered through the recirculation process to further increase the efficiency of the oxidation reactions.

Following the oxidation process, the produced water may be sanitized or disinfected using electromagnetic radiation, such as ultraviolet (UV) light or any other appropriate process to remove bacteria and other biological contaminants. For example, the sanitizing process may include exposure of the produced water to ultraviolet radiation across the UV wavelength range ranging from about 200 nm to about 300 nm, inclusive, such as within the range from about 240 nm to about 280 nm. Such UV radiation may be produced by low, medium, or high-pressure vapor lamps, such as mercury vapor lamps or the equivalent, sized in accordance with the needs of the overall system of the present disclosure. Variables to be considered in selecting the UV system for use herein include, but are not limited to, flow rate, flow profile, fluid turbulence, lamp power, and UV transmittance in the fluid.

The oxidation process and the sanitizing process may be applied simultaneously. For example, it may be beneficial to process efficiency to implement an oxidizing process using ozone with a simultaneous sanitizing process using UV radiation. During recirculation in an oxidation tank in which the produced water is subjected to sequential aeration with ozone micro bubbles and filtration, the produced water may be passed through a UV light array emitting UV radiation in the wavelength range from about 200 nm to about 300 nm. The recirculation process would maximize the effectiveness of both the oxidation through ozone process and the sanitizing process.

It should be noted that the combination of the electro-coagulation process with an oxidation process using ozone in a single water treatment method results in synergistic efficiencies in the overall water treatment method. Specifically, electro-coagulation has a tendency to raise the pH of the fluids to a basic level (e.g., a pH of 8 or above); ozone (O₃) has a tendency to acidify fluids. Thus, if the fluid treatment ended with electro-coagulation, it would be necessary to adjust the pH of the resulting fluid by adding an acidifying agent, such as an inorganic acid. In the process and method disclosed herein, no acids or acidifying chemicals need to be added to the produced water, as the oxidation with ozone—or ozonation—can be relied upon to bring the produced water from its basic pH following the electro-coagulation to a substantially circumneutral pH (pH of about 7). Following the ozonation, if it is still oxygenated, the produced water may be contacted with another inert gas, e.g. nitrogen (N₂), to purge free oxygen remaining in the system.

Major components of wastewater and production water streams suitable for treatment using the methods and systems described herein may include dissolved and dispersed oil compounds, dissolved formation minerals, production chemical compounds, production solids (including formation solids, corrosion and scale products, bacteria, waxes, and asphaltenes), and dissolved gases.

Dissolved and dispersed oil compounds which may be contained within the production water, and which are capable of being removed in accordance with the treatment and purification methods of the present disclosure includes oils (mixtures of hydrocarbons, including benzene, toluene, ethylbenzene, and xylenes (BTEX), naphthalene, phenantherene, dibenzothiophene (NPD), polylaromatic hydrocarbons (PAHs), and phenols. As water cannot dissolve all hydrocarbons, most of the oil is dispersed within the water, with the remainder being suspended. The amounts of dissolved and suspended oils present in produced water (prior to treatment) vary in accordance with a number of factors, including oil composition, pH, salinity, TDS (total dissolved solids), temperature, type and quantity of oilfield chemicals used in hydrocarbon recovery operations, type and quantity of various stability compounds (e.g., waxes, asphaltenes, and fine solids), and the oil-to-water ratio.

Dissolved formation minerals which may be contained within the production water, and which are capable of being removed in accordance with the treatment and purification methods of the present disclosure include but are not limited to cations (such as Na⁺, K⁺, Ca²⁺, Mg²⁺, Ba²⁺, Sr²⁺, and Fe²⁺) and anions (such as Cl⁻, SO₄²⁻, CO₃²⁻, and HCO₃⁻) that can affect produced water chemistry in terms of buffering capacity, salinity, and scale potential; heavy metals, such as cadmium, chromium, copper, lead, mercury, nickel, silver and zinc, the amounts and concentrations of which will depend on the age of the wells and the formation geology; and, naturally occurring radioactive materials (NORM), which primarily occurs in the form of radium isotopes (²²⁶Ra and ²²⁸Ra) that are co-precipitated along with other types of scales, e.g., barium sulfate.

Production chemical compounds that may be which may be contained within the production water, and which are capable of being removed in accordance with the treatment and purification methods of the present disclosure include but are not limited to those chemicals added during the hydrocarbon recovery and production process, including treatment chemicals (production treating chemicals, gas processing chemicals, and stimulation chemicals), and production treating chemicals (scale and corrosion inhibitors, biocides, emulsion breakers, antifoam and water treatment chemicals), and a wide range of various polar and charged molecules including but not limited to linear alkylbenzene sulfonate (LAS), alkyldimethylbenzenylammonium compounds, 2-alkyl-1-ethylamine-2-imidazolines, 2-alkyl-1-[N-ethylalkylamide]-2-imidazolines, and di-[alkyldimethylammonium-ethyl]ethers that have been characterized in commercial formations and/or in the water produced from oilfields [see, for example, McCormack, et al., Water Research, Vol. 35, pp. 3567-3578 (2001)].

Production solid materials which may be contained within the production water, and which are capable of being removed in accordance with the treatment and purification methods of the present disclosure include a wide range of materials including but not limited to formation solids, corrosion and scale products, bacteria, waxes, and asphaltenes, as well as bacteria such as Gram-positive bacteria known to clog or cause corrosion of equipment and pipelines, and inorganic crystalline substances such as SiO₂, Fe₂O₃, Fe₃O₄, and BaSO₄ found in the suspended solids (SS) in produced water.

Dissolved gases which may be contained within the production water, and which are capable of being removed in accordance with the treatment and purification methods of the present disclosure include such common gases as carbon dioxide (CO₂), oxygen (O₂), and hydrogen sulfide (H₂S), among others.

As described herein, the processes and systems useful in the treatment and reclamation of waste and produced water are preferably applicable to substantially non-viscosified, Newtonian fluids having a viscosity ranging from about 0.1 cP to about 50 cP, preferably from about 1 cP to about 15 cP, inclusive. It is preferable that non-Newtonian fluids (those fluids having viscosities of greater than about 50 cP) are not included in the purification methods described herein. Examples of high-viscosity non-Newtonian fluids which are preferably avoided in the employment of the methods of the present disclosure include water gels, hydrocarbon gels and hydrocarbon-in-water or, optionally, water-in-hydrocarbon emulsions, as well as water gels formed by combining water with natural gums, carboxymethyl, cellulose, carboxymethyl hydroxy ethyl cellulose, polyacrylamide and starches. Chemical complexes of the above compounds formed through chemical cross-linking are also preferably not included in the methods of the present disclosure.

Regarding the ozone treatment of the fluid stream, following the treatment with the diffused air filtration system, if appropriate (e.g., if the water stream to be purified contains a large amount of metals and other inorganic or organic contaminants that are oxidizable with ozone (O₃) and which will form insoluble solids capable of being removed by filtration or similar solids separation means). For example, it is known that ozone oxidizes iron from Fe (II) to Fe (III). Ferric ions (Fe (III)) hydrolyze to Fe(OH)₃, which precipitates to a solid form which can be filtered. The oxidation reaction requires approximately 0.43 mg of ozone per mg of ferrous ion (Fe (II)) in solution. Excess ozone can be used without negative effect. Iron preferably oxidizes in the pH range of pH 6-9. Similarly, ozone oxidizes manganese in the +2 oxidation state (Mn (II)) to MnO₂ (Mn IV; manganese oxide), which is insoluble and can be filtered out of the water. The oxidation reaction requires approximately 0.88 mg of ozone per mg of Mn (II). Excess ozone beyond this ratio will form water-soluble Mn (VII), permanganate. If oxidizable organic material is present in the water and there is sufficient contact time, permanganate will be reduced back to MnO₂ (Mn (IV)). Typically, manganese oxidation is most effective around a pH of about pH 8. In general, when organic materials are present in the water, more ozone will be required than the amount suggested above, since ozone will also oxidize these materials. The nature of the precipitate formed during this stage of the purification process will depend on the temperature and water chemistry of the water being purified. Importantly, this ozone oxidation stage of the process must occur at a fluid temperature of less than about 105° F., to prevent the formation of unwanted ozone decomposition products.

The following examples are included to demonstrate preferred embodiments of the invention. It should be appreciated by those of skill in the art that the techniques disclosed in the examples which follow represent techniques discovered by the inventor(s) to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the scope of the invention.

### EXAMPLES

### Example 1

### Treatment of a Produced Water Stream

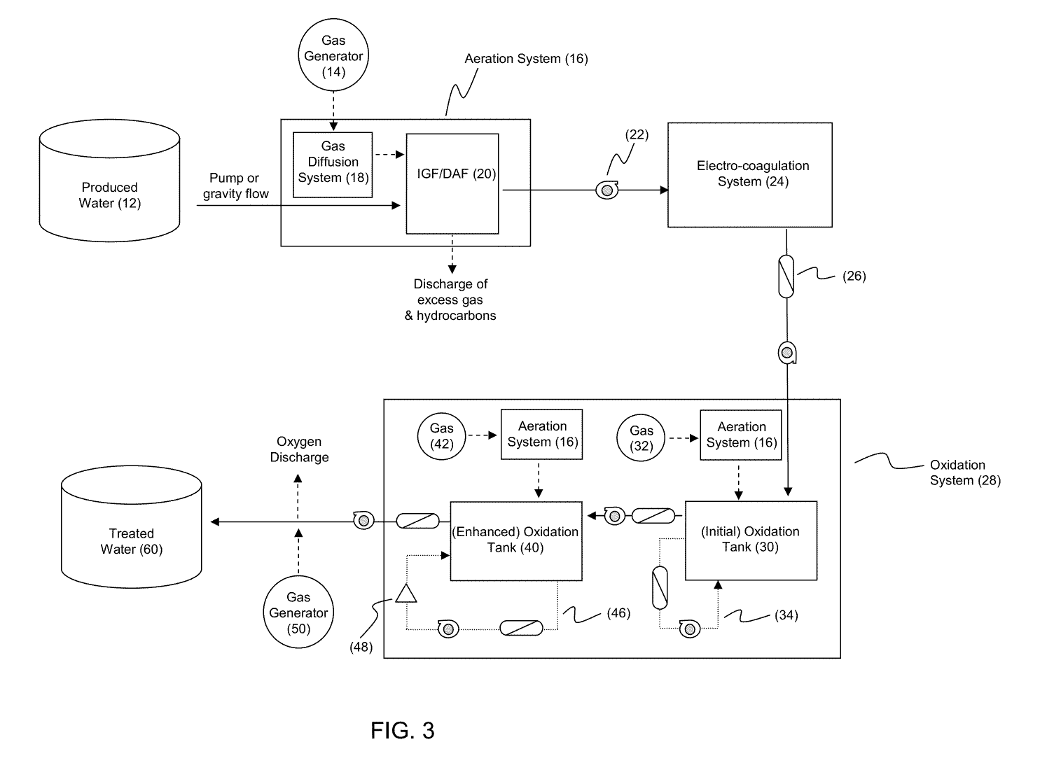

A produced water stream may be purified by passing the waste stream through a series of treatment “stages”, each stage acting in concert to separate various impurities within the initial produced water stream. This general process of purification is illustrated schematically in FIG. 3. Initially, the stream of produced water (12) enters a gas-induced hydrocarbon separation stage, wherein oil entrained within the fluid stream is separated from the water using an inert gas, such as nitrogen (N₂) or carbon dioxide (CO₂) gas delivered from tanks or a gas generator (14), using an aeration system (20) that may be any system suitable for and capable of creating and delivering very small (e.g., ranging from about 1 μm to about 10 μm, preferably about 5 μm) gas bubbles into the fluid flow stream in order to enhance the oil recovery of the produced water, and remove a bulk of the hydrocarbons. As depicted in the figure, the aeration system (16) may contain a gas diffusion system (18) as discussed above, but which could also consist of an impeller, eductors, or a sparger. Using gas provided by the gas generator (14), the gas diffusion system (18) creates micro bubbles which, in turn, are provided to a IGF or DAF system (20) or other suitable gas injection or diffusion systems known in the art.

Thereafter, the fluid stream is pumped (22) to an electro-coagulation system (24); this electro-coagulation stage is used to increase efficiency of the system. As the fluid contacts the electro-coagulation system (24), electro-flocculation occurs, generating iron-based flocculant/suspended solids (SS) in the fluid stream. Following the electro-coagulation step, the fluid is contacted with a filter system (26) and pumped (22) to an oxidation system (28).

The oxidation system comprises at least an initial oxidation tank (30) into which an appropriate gas (32) oxidation agent is diffused or injected by use of an aeration system (16). This gas (32) may be ozone, ambient air, enriched oxygen, carbon dioxide, or any other suitable oxidation agent as dictated to a person of skill in light of the composition of the fluid stream. In addition to the removal of hydrocarbons, this oxidation step will serve to oxidize any metals within the fluid stream that will react with ozone, including but not limited to iron (Fe), barium (Ba), strontium (Sr), and a number of other heavy metals. Optionally, the fluid stream is re-circulated (34) continuously through the initial oxidation tank (30) to increase the efficiency and effectiveness of the oxidation process. The re-circulation path (34) may contain a filtration assembly (26) and pump (22). Filtration of the fluid stream using filtration assembly (26) would occur during this continuous re-circulation. The filtration assembly may be used to remove oxidized contaminant particulate matter from the fluid stream, thereby increasing the efficiency of further oxidation activity. Alternatively and optionally, the filtration of the fluid stream may be staged, allowing sufficient time following the initial oxidation for oxidation reactions to progress and the oxidation products to coagulate or flocculate prior to initiating filtration and/or re-circulation with filtration.

From the initial oxidation tank (30), the fluid stream would be filtered (22) and would pass into an optional second oxidation tank (40) where a second suitable gas (42) oxidizing agent is diffused or injected by use of an aeration system (16). Where the fluid stream in the initial oxidation tank (30) may be injected or diffused with ambient air or other moderately-oxidizing gas, the fluid stream in the enhanced oxidation tank (40) would be injected or diffused with an additional oxidizing agent such as, but not limited to, ozone (O₃) gas. In such a case, the gas (42) source would be an ozonation system. In this manner, any remaining hydrocarbons in the fluid stream will be oxidized, and can be carried out of the fluid stream by way of an appropriate carrier gas stream, such as a CO₂-waste stream. As appropriate, the fluid stream may optionally be re-circulated through the second oxidation tank through a pump (22), where the pump (22) could be used in conjunction with one or more optional filter assemblies (26) in order to remove any solids formed from the fluid stream. Thereafter, the fluid stream would be optionally re-circulated (46) from the oxidation tank (40) in order to maximize the efficiency of oxidation via ozonation. Advantageously, a filtration step prior to initiating further contact between the fluid stream and ozone in the oxidation step would eliminate any continued, undesirable reactions between the precipitates and the simultaneously maximize the efficiency of the ozone oxidation. Alternatively and optionally, the filtration of the fluid stream in the enhanced oxidation tank may be staged, allowing sufficient time following the introduction of the enhanced oxidizing agent to allow oxidation reactions to progress and the oxidation products to coagulate or flocculate prior to initiating filtration and/or re-circulation with filtration

As appropriate, the re-circulation of the fluid stream would also optionally allow for the use of a sanitization system (48), such as a sanitizing ultra-violet light assembly that would treat the passing fluid stream with ultra-violet radiation of wavelengths suitable for destroying biological contaminants. Where only a an initial oxidation tank (28) is used in the oxidation system (26), the sanitation system (48) may instead be used in association with the initial oxidation tank (28).

At this point, the produced fluid stream will contain a high degree of oxygenated water. In order to prevent future undesirable reactions of such oxygenated water with fluid transport lines, metal containers, and the like, the fluid is contacted with an additional gas (e.g., nitrogen) diffusion system (50) in order to remove oxygen from the water (the de-oxygenation stage) prior to the electro-coagulation treatment. Post de-oxygenation, the fluid stream is pumped (18) to a holding tank (60) or other suitable vessel for pipeline for storage, use, or transport.

As a general note, produced fluids are generally fairly clean (compared to fracturing fluids and drilling fluids, for example), and may contain only hydrocarbons and salts. Nevertheless, there may be solids and clays—which react favorably to flocculation—and therefore an enhanced purity fluid may be obtained by passing the fluid through the electro-coagulation system (20).

### Example 2

### Treatment of a Fracturing Flow-Back Water

Generally, fracturing flow-back water (also referred to as “frac flow-back water”) contains a high concentration of dissolved minerals as a consequence of the fracturing process itself. Typically, while the fracturing flow-back fluid is heavier in salts and dissolved metals than produced water, it may or may not contain hydrocarbons, depending upon whether it was taken from an oil or a gas well.

The general process of purification for fracturing fluid flow-back water is generally the same as that outlined above regarding the purification of produced water. Initially, the fracturing fluid flow-back water stream is contacted with a gas-induced hydrocarbon separation stage, wherein oil entrained within the fluid stream is separated from the water using an inert gas, such as nitrogen (N₂) gas delivered from tanks or a gas generator, using a diffused air flotation (DAF) system. As above, this system acts to diffuse very small (e.g., ranging from about 1 μm to about 10 μm, preferably about 5 μm) gas bubbles into the fluid flow stream in order to enhance the oil recovery of the produced water, and remove a bulk of the hydrocarbons.

Thereafter, the fluid stream is treated with carbon dioxide in order to accelerate the flocculation process, as carbon dioxide (CO₂) has a tendency to react very quickly with clay fines and silt particles. The CO₂ may come from any appropriate CO₂-producing means. As appropriate, the fluid stream will then be passed through one or more filter assemblies in order to remove any solids formed from the fluid stream, and thereafter the stream will be re-circulated through the carbon-dioxide treatment system in order to maximize the efficiency of this step of the process. Advantageously, this filtration step prior to initiating further contact between the fluid stream and CO₂ gas in the reaction step eliminates any continued, undesirable reactions between the precipitates. The pH of the fluid stream at this point will again be slightly acidic (pH ranging from about pH 3 to about pH 6).

At this point, the produced fluid stream will contain a high degree of oxygenated water. In order to prevent future undesirable reactions of such oxygenated water with fluid transport lines, metal containers, and the like, the fluid is contacted with a second gas (e.g., nitrogen) diffusion system in order to remove oxygen from the water (the de-oxygenation stage) prior to the electro-coagulation treatment.

Post de-oxygenation, the fluid stream then contacts an electro-coagulation system; this electro-coagulation stage is used to increase efficiency of the system. As the fluid contacts the electro-coagulation system, electro-flocculation occurs, generating iron-based flocculant/suspended solids (SS) in the fluid stream. The fluid is contacted with the electro-coagulation system for a period of time sufficient to raise the pH of the fluid back to approximately neutral, about pH 7, while simultaneously generating a high degree of flocculation in a short amount of time. Following the electro-coagulation step, the fluid is again contacted with a second filter system and, if determined to be still oxygenated, is optionally subjected to another gas (e.g., N₂) stream to purge any free oxygen remaining in the system from the fluid, thereafter producing the final, treated water product.

### Example 3

### Treatment of an Aqueous Drilling Fluid

This is similar to the process described above concerning the treatment of fracturing fluids, with the possible addition of further recirculation or passing over EC plates a plurality (two or more) of times, due to the presence of the additional solids (mostly clays and silts).

As is evident from the prophetic process examples discussed above, it is evident that the methods described herein have great flexibility due in part to the variety of gases that can be employed within the overall process to achieve various results. In general terms, the process can employ both inert and reactive other gases to achieve various purposes, as appropriate. For example, while nitrogen gas (N₂) would generally be used to separate hydrocarbons from the water, carbon dioxide (CO₂) may be also be used as a reactive gas, as may methane (CH₄) and hydrogen (H₂).

Other and further embodiments utilizing one or more aspects of the inventions described above can be devised without departing from the spirit of Applicant's invention. For example, other purification methods and processes can be included into the methods and systems described herein without departing from the invention. Further, the various methods and embodiments of the described purification methods can be included in various combinations with each other to produce variations of the disclosed methods and embodiments. Discussion of singular elements can include plural elements and vice-versa.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range of equivalent of the following claims

What is claimed is:

1. A water treatment method, the method comprising:
transferring water contaminated with at least one contaminant selected from the group consisting of inorganic compounds, organic compounds, and gases;
contacting the contaminated water with a diffusion-aeration treatment system for introducing diffused bubbles into a stream of contaminated water, thereby generating a volatile organic fraction containing hydrocarbon molecules and a contaminated diffusion-aeration system effluent;
aerating the diffusion-aeration system effluent in an aeration system for a residence time sufficient to generate an aeration system effluent;
separating solids from the aeration system effluent with a filter means to generate a filtered aeration effluent stream;
contacting the filtered aeration effluent stream with an electro-coagulation system for a residence time sufficient to generate flocculants in the electro-coagulation system effluent; and
separating solids from the electro-coagulation system effluent with a filtration system to obtain an aqueous fluid stream with a pH of about 7.

2. The method of claim 1, wherein the contaminated water is selected from the group consisting of produced water, formation water, fracturing flow-back water, and aqueous-based drilling fluids.

3. The method of claim 1, further comprising adjusting the pH of the collection water to a pH value of not less than approximately 6.7.

4. The method of claim 1, further comprising treating the contaminated diffusion-aeration system effluent with an ozone containing gas under a differential pressure for a time sufficient to substantially render oxidation products of water soluble organics and inorganics within the fluid stream, the oxidation products being substantially water insoluble.

5. The method of claim 1, wherein the feedstream of contaminated water has a temperature ranging from about 77° F. (about 25° C.) to about 200° F. (about 93° C.).

6. The method of claim 4, wherein the differential pressure is between from about 2 psi to about 50 psi.

7. The method of claim 1, the contaminated water having a fluid flow rate through the system ranging from about 1 bbl/min. to about 100 bbl/min.

8. The method of claim 4, wherein the temperature of the feedstream during treatment with an ozone containing gas is less than about 105° F.

9. A water treatment method, the method comprising:
collecting water contaminated with at least one contaminant selected from the group consisting of inorganic compounds, organic compounds, and gases to create a collection water;
electro-coagulating solids and/or metals entrained in the collection water to generate flocculants in the aeration effluent thereby creating an electro-coagulation effluent;
aerating the electro-coagulation effluent with at least one oxidizing agent to reduce metals, hydrocarbons, or other reducing agents in the filtered electro-coagulation effluent to create an aeration-oxidation effluent;
sanitizing the aeration-oxidation effluent to create a sanitized effluent;
degassing the sanitized effluent for a sufficient time to allow the removal of a substantial portion of any gaseous oxidation agent from the sanitized aeration-oxidation effluent creating a final effluent; and
storing the final effluent.

10. The method of claim 9, wherein the method of aerating the electro-coagulation effluent further comprises:
aerating the electro-coagulation effluent with a first oxidizing agent to create an first oxidized electro-coagulation effluent; and
aerating the first oxidized electro-coagulation effluent with a second oxidizing agent to create the aeration-oxidation effluent.

11. The method of claim 10, wherein the electro-coagulation effluent is aerated with a gas by a method selected from the group consisting of dissolved air floatation and induced gas floatation.

12. The method of claim 10, wherein the first oxidizing agent consists substantially of ambient air and the second oxidizing agent consists substantially of ozone.

13. The method of claim 9, further comprising a method of filtering the electro-coagulation effluent to remove the flocculants from the electro-coagulation effluent prior to aerating the electro-coagulation effluent.

14. The method of claim 10, further comprising a method of filtering the first oxidized electro-coagulation effluent prior to aerating the first oxidized electro-coagulation effluent with the second oxidizing agent.

15. The method of claim 9, wherein the sanitizing of the aeration-oxidation effluent comprises exposing the aeration-oxidation effluent to radiation of a sufficient wavelength and for a sufficient time to destroy substantially all microorganism contamination.

16. A system of treating contaminated water, the system comprising:
an aeration assembly for introducing diffused gas bubbles into a stream of contaminated water, thereby generating a volatile organic fraction containing hydrocarbon molecules and a contaminated first aqueous fraction;
an electro-coagulation system in fluid communication with the diffusion-aeration assembly for the electrolytic treatment of the fluid stream, the electro-coagulation system comprising at least one reactor cartridge configured for installation into and removal from the electro-coagulation system, the at least one reactor cartridge comprising a plurality of electrodes formed of a selected material and having a selected configuration; and
a means for transporting the fluid from the diffusion-aeration assembly to the electro-coagulation system.

17. The system of claim 16, further comprising an oxidation means associated with the aeration assembly and capable of being in contact with the aqueous feed stream.

18. The system of claim 17, wherein the oxidation means is an ozone-containing gas stream.

19. The system of claim 16, further comprising one or more filter assemblies in fluid communication with the aqueous feed stream.

20. The system of claim 16, further comprising pumping means for pumping the aqueous feed stream from the diffusion-aeration assembly to the electro-coagulation-system.
